(19) United States
(12) Patent Application Publication
(10) Pub. No.: US 2026/0361333 A1
(43) Pub. Date: Nov. 12, 2026

(54) RADIO-FREQUENCY MODULE

(71) Applicant: Murata Manufacturing Co., Ltd., Nagaokakyo-shi (JP)

(72) Inventors: Keisuke ARIMA, Nagaokakyo-shi (JP); Syunsuke KIDO, Nagaokakyo-shi (JP); Akira MICHIGAMI, Nagaokakyo-shi (JP)

(73) Assignee: Murata Manufacturing Co., Ltd., Nagaokakyo-shi (JP)

(21) Appl. No.: 19/723,002

(22) Filed: Jun. 29, 2026

Related U.S. Application Data
(63) Continuation of application No. PCT/JP2024/042800, filed on Dec. 4, 2024.

(30) Foreign Application Priority Data
Jan. 24, 2024 (JP) 2024-008756

(51) Int. Cl. H04B 1/40; H04B 1/04

(52) U.S. Cl. CPC H04B 1/40; H04B 2001/0408

(57) ABSTRACT

A radio-frequency module includes a module substrate, a power amplifier on the module substrate, a first filter on the module substrate having a passband that includes a transmission band of a first frequency division duplex (FDD) band (band A) corresponding to a first power class, and connected to the power amplifier, and a second filter on the module substrate having a passband different from that of the first filter. The passband of the second filter may include a second FDD band (band B) corresponding to a second power class defined by a maximum output power lower than the first power class or a first time division duplex (TDD) band (band B) corresponding to the first power class or the second power class. In a plan view of the module substrate, the second filter is between the power amplifier and the first filter.

### CROSS-REFERENCE TO RELATED APPLICATIONS

This application is a continuation application filed under 35 U.S.C. § 111(a) claiming benefit under 35 U.S.C. § 120 of International Application No. PCT/JP2024/042800, filed on Dec. 4, 2024, which claims priority under 35 U.S.C. § 119(a) to Japanese Patent Application No. 2024-008756, filed on Jan. 24, 2024. The entire contents of each of the strictly identified prior applications are incorporated herein by reference.

### TECHNICAL FIELD

The present disclosure relates to a radio-frequency module.

### BACKGROUND ART

In3GPP (registered trademark) (3rd Generation Partnership Project) and the like, the use of power classes (e.g., power classes 2, 1.5, 1, etc.) defined by maximum output powers higher than those of conventional power classes is being considered for frequency division duplex (FDD) bands.

### CITATION LIST

### Patent Documents

Patent Document 1: Japanese Unexamined Patent Application Publication No. 2017-063315

### SUMMARY

A radio-frequency module according to an aspect of the present disclosure includes: a module substrate; a first power amplifier disposed on the module substrate; a first filter disposed on the module substrate, having a passband that includes a transmission band of a first FDD band corresponding to a first power class, and connected to the first power amplifier; and a second filter disposed on the module substrate, and having a passband that includes a transmission band of a second FDD band corresponding to a second power class defined by a maximum output power lower than that of the first power class, a first TDD band corresponding to the first power class, or a second TDD band corresponding to the second power class, wherein, in a plan view of the module substrate, the second filter is disposed between the first power amplifier and the first filter.

According to the present disclosure, deterioration of filter characteristics due to heat can be suppressed.

### BRIEF DESCRIPTION OF DRAWINGS

FIG. 1 is a circuit configuration diagram of a communication device according to Embodiment 1.

FIG. 2 is a plan view of a radio-frequency module according to Embodiment 1.

FIG. 3 is a plan view of the radio-frequency module according to Embodiment 1.

FIG. 4 is a cross-sectional view of the radio-frequency module according to Embodiment 1.

FIG. 5A is a partial cross-sectional view of a filter according to Embodiment 1.

FIG. 5B is a partial cross-sectional view of the filter according to Embodiment 1.

FIG. 5C is a partial cross-sectional view of the filter according to Embodiment 1.

FIG. 6 is a plan view of the radio-frequency module according to Modification 1 of Embodiment 1.

FIG. 7 is a plan view of the radio-frequency module according to Modification 2 of Embodiment 1.

FIG. 8 is a circuit configuration diagram of a communication device according to Embodiment 2.

FIG. 9 is a plan view of a radio-frequency module according to Embodiment 2.

FIG. 10 is a circuit configuration diagram of a communication device according to Embodiment 3.

FIG. 11 is a plan view of a radio-frequency module according to Embodiment 3.

FIG. 12 is a plan view of the radio-frequency module according to Embodiment 3.

FIG. 13 is a plan view of the radio-frequency module according to Modification 1 of Embodiment 3.

### DESCRIPTION OF EMBODIMENTS

The inventors have recognized that, when a maximum output power higher than conventional levels is allowed in an FDD band in the radio-frequency circuit described in Patent Document 1, filter characteristics may deteriorate due to heat.

Accordingly, the present disclosure is directed to a radio-frequency module capable of suppressing deterioration of filter characteristics due to heat.

Hereinafter, embodiments of the present disclosure will be described in detail using the drawings. It should be noted that the embodiments described below are comprehensive or specific examples. The numerical values, shapes, materials, components, arrangement and connection forms of components, and the like illustrated in the following embodiments are merely examples and are not construed as limiting the present disclosure.

Note that the drawings are schematic diagrams in which certain components have been appropriately emphasized, omitted, or scaled for the purpose of illustrating the present disclosure. Accordingly, they are not necessarily depicted with strict accuracy and may differ from the actual shapes, positional relationships, and proportions. In the drawings, the same reference numerals are given to substantially identical configurations, and repeated explanations may be omitted or simplified.

In the following drawings, the x-axis and the y-axis are axes orthogonal to each other on a plane parallel to a principal surface of a module substrate. Specifically, when the module substrate has a rectangular shape in a plan view, the x-axis is parallel to a first side of the module substrate, and the y-axis is parallel to a second side orthogonal to the first side of the module substrate. Additionally, the z-axis is an axis perpendicular to the principal surface of the module substrate, the positive direction of which indicates the upward direction, and the negative direction of which indicates the downward direction.

In the following description of a circuit configuration, the term “connected” includes not only a case in which elements are directly connected by a connection terminal and/or a wiring conductor, but also a case in which they are electrically coupled with another circuit element interposed therebetween. The expression “A is switchably connected to B” means that the connection and disconnection of A and B is switchable, i.e., A is connected to B with a switch interposed therebetween. Note that the expression “A is connected to B” includes “A is switchably connected to B”. The expression “C is connected between A and B” means that one of two ends of C is connected to A and the other end of C is connected to B, i.e., C is connected in series with a path connecting A and B. The term “path connecting A and B” refers to a path composed of a conductor electrically coupling A to B.

The term “terminal” refers to a point at which a conductor within an element terminates. When the impedance of a conductor between elements is sufficiently low, a terminal is interpreted not only as a single point but also as any point on the conductor between the elements, or as the entire conductor.

The term “passband of a filter” refers to a portion of a frequency spectrum that is transmitted through the filter, and is defined as the frequency range in which the output power is not attenuated by more than3 dB from the maximum output power. Accordingly, the upper end and the lower end of the passband of a band-pass filter are specified as the higher frequency and the lower frequency, respectively, of two points at which the output power is attenuated by 3 dB from the maximum output power.

The term “transmission band” refers to a frequency band used for transmission in a communication device, and the term “reception band” refers to a frequency band used for reception in a communication device. For example, in an FDD band, different frequency bands (uplink band and downlink band) are used as the transmission and reception bands. Additionally, for example, in a Time Division Duplex (TDD) band, the same frequency band is used as both the transmission and reception bands.

The term “power class” is a classification of output power of user equipment (UE) defined by the maximum output power, and indicates that a smaller value of the power class allows a higher maximum output power. For example, in3GPP, power classes 1, 1.5, 2, and 3 are defined. Specifically, for power class 1, the maximum output power is defined as 31 dBm. For power class 1.5, the maximum output power is defined as 29 dBm. For power class 2, the maximum output power is defined as 26 dBm. For power class 3, the maximum output power is defined as 23 dBm. The maximum output power values recited herein are based on3GPP Release 15 and subsequent releases, and the power class definitions are not limited to any particular release.

Note that the maximum output power of UE is defined as the maximum output power at an antenna end. Measurement of the maximum output power of UE is performed by a method defined by 3GPP or the like. For example, the maximum output power is measured by measuring radiated power at the antenna. Alternatively, instead of measuring the radiated power, the maximum output power of the antenna may be measured by providing a terminal in the vicinity of the antenna and connecting a measuring instrument (e.g., a spectrum analyzer) to the terminal.

The expression “a band corresponding to a power class” refers to a frequency band where the power class can be used, and is defined by a standard or the like. For example, in3GPP, n1, n2, n3, n5, n8, n13, n25, n26, n28, n66, n71, and n85 are being considered as FDD bands for 5G NR corresponding to power class 2. A band “corresponding to” a power class means that the power class is applicable to user equipment operating in that band, as defined by a applicable wireless communication standard.

The expression “a component is disposed on a substrate” includes both a case where the component is disposed on a principal surface of the substrate and a case where the component is disposed within the substrate. The expression “a component is disposed on a principal surface of a substrate” includes not only a case where the component is disposed in contact with the principal surface of the substrate but also a case where the component is disposed above the principal surface without being in contact with the principal surface (e.g., stacked on another component disposed in contact with the principal surface). Additionally, the expression “a component is disposed on a principal surface of a substrate” may also include a case where the component is disposed in a recess formed in the principal surface. The expression “a component is disposed within the substrate” includes a case where the component is encapsulated in the substrate, a case where the entire component is disposed between the two principal surfaces of the substrate with a portion of the component remaining covered by the substrate, and a case where only a portion of the component is disposed within the substrate.

The expression “A is disposed between B and C” means that at least one of the multiple line segments connecting any point in B to any point in C passes through A. The expression “A is disposed closer to C than B” means that the distance between A and C is shorter than the distance between B and C. Conversely, “A is disposed farther from C than B” means that the distance between A and C is longer than the distance between B and C. The “distance between A (B) and C” refers to the length of the shortest line segment among the multiple line segments connecting any point in A (B) to any point in C.

The expression “a plan view of a module substrate” refers to viewing an object by orthogonally projecting the object onto a plane parallel to a principal surface of the module substrate from above the module substrate. That is, the expression “a plan view of a module substrate” means viewing an object by orthogonally projecting the object onto the xy-plane from the positive side of the z-axis.

The expression “a bandgap of a semiconductor material” refers to an energy difference between the top of the valence band and the bottom of the conduction band in the semiconductor material. The bandgap is a value inherent to a semiconductor material and is specified by identifying the semiconductor material.

Terms indicating relationships between elements, such as “parallel” and “perpendicular”, and terms indicating the shapes of elements, such as “rectangular”, as well as numerical ranges, do not only denote strict meanings but also include substantially equivalent ranges, for example, with an error of several percent.

### Embodiment 1

Embodiment 1 will be described. A communication device 5 according to the present embodiment can be used to provide a wireless connection. For example, the communication device 5 can be implemented in UE in a cellular network (also referred to as a mobile network), such as a mobile phone, a smartphone, a tablet computer, or a wearable device. In another example, by implementing the communication device 5, a wireless connection can be provided to an IoT (Internet of Things) sensor device, a medical/healthcare device, a vehicle, an unmanned aerial vehicle (UAV) (so-called drone), or an automated guided vehicle (AGV). In yet another example, by implementing the communication device 5, a wireless connection can also be provided at a wireless access point or a wireless hotspot.

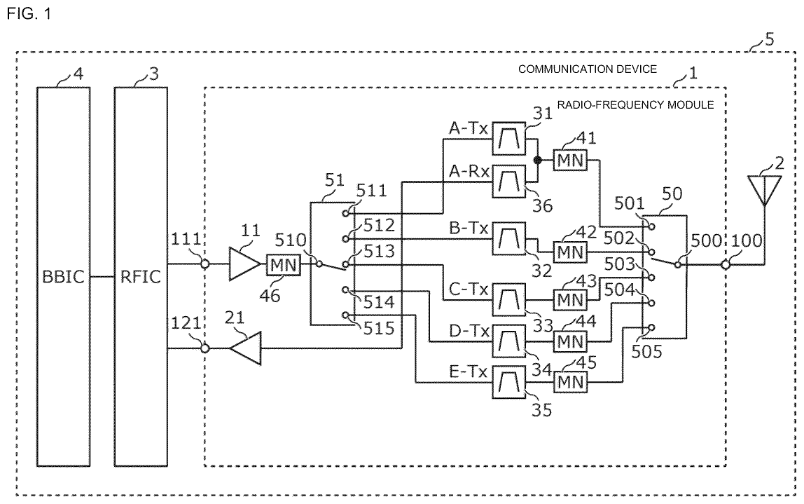

The circuit configuration of the communication device 5 and a radio-frequency module 1 according to the present embodiment will be described with reference to FIG. 1. FIG. 1 is a circuit configuration diagram of the communication device 5 according to the present embodiment.

Note that FIG. 1 illustrates an exemplary circuit configuration, and the communication device 5 and the radio-frequency module 1 may be implemented using any of various circuit implementations and circuit technologies. Accordingly, the description of the communication device 5 and the radio-frequency module 1 provided below is not to be construed as limiting.

### 1.1 Circuit Configuration of Communication Device 5

First, the circuit configuration of the communication device 5 according to the present embodiment will be described with reference to FIG. 1. The communication device 5 includes the radio-frequency module 1, an antenna 2, an RFIC (Radio Frequency Integrated circuit) 3, and a BBIC (Baseband Integrated Circuit) 4.

The radio-frequency module 1 is capable of transmitting radio-frequency signals between the antenna 2 and the RFIC 3. The circuit configuration of the radio-frequency module 1 will be described later.

The antenna 2 is connected to an antenna connection terminal 100 of the radio-frequency module 1. The antenna 2 is capable of receiving a radio-frequency signal from the radio-frequency module 1 and transmitting it to the outside of the communication device 5. The antenna 2 is also capable of receiving a radio-frequency signal from outside the communication device 5 and outputting it to the radio-frequency module 1. Note that the antenna 2 need not necessarily be included in the communication device 5. The communication device 5 may further include one or more antennas in addition to the antenna 2.

The RFIC 3 is an example of a signal processing circuit that processes radio-frequency signals. Specifically, the RFIC 3 is capable of performing signal processing on a transmission signal input from the BBIC 4 by up-conversion or the like, and outputting a radio-frequency transmission signal generated by the signal processing to the radio-frequency module 1. Further, the RFIC 3 is capable of performing signal processing on a radio-frequency reception signal input through a reception path of the radio-frequency module 1 by down-conversion or the like, and outputting a reception signal generated by the signal processing to the BBIC 4. The RFIC 3 may also include a control unit that controls switches, amplifiers, and other components included in the radio-frequency module 1. Note that some or all of the functions of the RFIC 3 as the control unit may be provided outside the RFIC 3, such as in the BBIC 4 or in the radio-frequency module 1.

The BBIC 4 is a baseband signal processing circuit that performs signal processing using a frequency band lower than that of radio-frequency signals transmitted by the radio-frequency module 1. As signals processed by the BBIC 4, for example, image signals for image display and/or audio signals for voice calls through a speaker are used. Note that the BBIC 4 need not necessarily be included in the communication device 5.

### 1.2 Circuit Configuration of Radio-frequency Module

Next, the circuit configuration of the radio-frequency module 1 according to the present embodiment will be described with reference to FIG. 1. The radio-frequency module 1 includes a power amplifier 11, a low-noise amplifier 21, filters 31, 32, 33, 34, 35, and 36, matching circuits 41, 42, 43, 44, 45 and 46, switch circuits 50 and 51, the antenna connection terminal 100, a radio-frequency input terminal 111, and a radio-frequency output terminal 121.

The antenna connection terminal 100 is an external connection terminal of the radio-frequency module 1. The antenna connection terminal 100 is connected to the antenna 2 outside the radio-frequency module 1 and to the switch circuit 50 inside the radio-frequency module 1. This allows the radio-frequency module 1 to supply a transmission signal to, and receive a reception signal from, the antenna 2 via the antenna connection terminal 100.

The radio-frequency input terminal 111 is an external connection terminal of the radio-frequency module 1. The radio-frequency input terminal 111 is connected to the RFIC 3 outside the radio-frequency module 1 and to the power amplifier 11 inside the radio-frequency module 1. This allows the radio-frequency module 1 to supply a transmission signal supplied from the RFIC 3 via the radio-frequency input terminal 111 to the power amplifier 11.

The radio-frequency output terminal 121 is an external connection terminal of the radio-frequency module 1. The radio-frequency output terminal 121 is connected to the RFIC 3 outside the radio-frequency module 1 and to the low-noise amplifier 21 inside the radio-frequency module 1. This allows the radio-frequency module 1 to supply a reception signal amplified by the low-noise amplifier 21 to the RFIC 3 via the radio-frequency output terminal 121.

The power amplifier 11 is an example of a first power amplifier and is connected between the radio-frequency input terminal 111 and the filters 31 to 35. Specifically, an input end of the power amplifier 11 is connected to the radio-frequency input terminal 111. In the meanwhile, an output end of the power amplifier 11 is switchably connected to the filters 31 to 35 with the matching circuit 46 and the switch circuit 51 interposed therebetween. The power amplifier 11 is capable of amplifying a transmission signal supplied from the RFIC 3 via the radio-frequency input terminal 111, using power supplied from a power source.

Note that part or all of the power amplifier 11 need not necessarily be included in the radio-frequency module 1. In this case, part or all of the power amplifier 11 may be connected between the RFIC 3 and the radio-frequency input terminal 111, or may be included in the RFIC 3.

The low-noise amplifier 21 is connected between the filter 36 and the radio-frequency output terminal 121. Specifically, an input end of the low-noise amplifier 21 is connected to the filter 36. In the meanwhile, an output end of the low-noise amplifier 21 is connected to the radio-frequency output terminal 121. The low-noise amplifier 21 is capable of amplifying a reception signal that has passed through the filter 36, using power supplied from the power source.

Note that part or all of the low-noise amplifier 21 need not necessarily be included in the radio-frequency module 1. In this case, part or all of the low-noise amplifier 21 may be connected between the radio-frequency output terminal 121 and the RFIC 3, or may be included in the RFIC 3.

The filter 31 is an example of a first filter and has a passband that includes the transmission band of band A. The filter 31 is connected between the antenna connection terminal 100 and the power amplifier 11. Specifically, one of two ends of the filter 31 is switchably connected to the antenna connection terminal 100 with the matching circuit 41 and the switch circuit 50 interposed therebetween. In the meanwhile, the other end of the filter 31 is switchably connected to the power amplifier 11 with the switch circuit 51 and the matching circuit 46 interposed therebetween. The filter 31 has an electric power handling capability corresponding to a first power class defined by a higher maximum output power. An “electric power handling capability corresponding to a power class” means that the filter is rated to handle the maximum output power defined for that power class without significant degradation of filter characteristics.

The first power class is a power class defined by a maximum output power higher than that of a second power class. The second power class is a power class defined by a maximum output power lower than that of the first power class. As the first power class, for example, power class 2, power class 1.5, power class 1, or the like is used. As the second power class, for example, power class 3 is used. Note that, when a new power class is defined in a standard, the new power class may be used as the first power class or the second power class in accordance with the maximum output power of the new power class.

The filter 32 is an example of a second filter and has a passband that includes the transmission band of band B. The filter 32 is connected between the antenna connection terminal 100 and the power amplifier 11. Specifically, one of two ends of the filter 32 is switchably connected to the antenna connection terminal 100 with the matching circuit 42 and the switch circuit 50 interposed therebetween. In the meanwhile, the other end of the filter 32 is switchably connected to the power amplifier 11 with the switch circuit 51 and the matching circuit 46 interposed therebetween.

The filter 33 is an example of a third filter and has a passband that includes the transmission band of band C. The filter 33 is connected between the antenna connection terminal 100 and the power amplifier 11. Specifically, one of two ends of the filter 33 is switchably connected to the antenna connection terminal 100 with the matching circuit 43 and the switch circuit 50 interposed therebetween. In the meanwhile, the other end of the filter 33 is switchably connected to the power amplifier 11 with the switch circuit 51 and the matching circuit 46 interposed therebetween. The filter 33 has an electric power handling capability corresponding to the first power class defined by a higher maximum output power. Note that the filter 33 need not necessarily be included in the radio-frequency module 1.

The filter 34 is an example of a fourth filter and has a passband that includes the transmission band of band D. The filter 34 is connected between the antenna connection terminal 100 and the power amplifier 11. Specifically, one of two ends of the filter 34 is switchably connected to the antenna connection terminal 100 with the matching circuit 44 and the switch circuit 50 interposed therebetween. In the meanwhile, the other end of the filter 34 is switchably connected to the power amplifier 11 with the switch circuit 51 and the matching circuit 46 interposed therebetween. The filter 34 has an electric power handling capability corresponding to the first power class. Note that the filter 34 need not necessarily be included in the radio-frequency module 1.

The filter 35 is an example of a fifth filter and has a passband that includes the transmission band of band E. The filter 35 is connected between the antenna connection terminal 100 and the power amplifier 11. Specifically, one of two ends of the filter 35 is switchably connected to the antenna connection terminal 100 with the matching circuit 45 and the switch circuit 50 interposed therebetween. In the meanwhile, the other end of the filter 35 is switchably connected to the power amplifier 11 with the switch circuit 51 and the matching circuit 46 interposed therebetween. Note that the filter 35 need not necessarily be included in the radio-frequency module 1.

The filter 36 is an example of a sixth filter and has a passband that includes the reception band of band A. The filter 36 is connected between the antenna connection terminal 100 and the low-noise amplifier 21. Specifically, one of two ends of the filter 36 is switchably connected to the antenna connection terminal 100 with the matching circuit 41 and the switch circuit 50 interposed therebetween. In the meanwhile, the other end of the filter 36 is connected to the low-noise amplifier 21.

Bands A to E are frequency bands for communication systems constructed using Radio Access Technology (RAT). Bands A to E are predefined by standardization organizations (such as 3GPP and IEEE (Institute of Electrical and Electronics Engineers)). Examples of communication systems include 5G NR (5th Generation New Radio) systems, LTE (Long Term Evolution) systems, and WLAN (Wireless Local Area Network) systems.

Band A is an example of a first FDD band and is an FDD band corresponding to the first power class. As band A, for example, n1, n3, n8, n26, n28, or n66 for 5G NR is used. Note that band A is not limited thereto. For example, an LTE band may be used as band A.

Band B is an example of a second FDD band, a first TDD band, and a second TDD band, and is an FDD band (second FDD band) corresponding to the second power class, a TDD band (first TDD band) corresponding to the first power class, or a TDD band (second TDD band) corresponding to the second power class. As band B, for example, n12, n13, n40, or n41 for 5G NR is used. Note that band B is not limited thereto. For example, an LTE band may be used as band B.

Band C is an example of a third FDD band and is an FDD band corresponding to the first power class. As band C, a frequency band different from band A is used; for example, n1, n3, n8, n26, n28, or n66 for 5G NR is used. Note that band C is not limited thereto. For example, an LTE band may be used as band C.

Band D is an example of a fourth FDD band and is an FDD band corresponding to the first power class. As band D, a frequency band different from bands A and C is used; for example, n1, n3, n8, n26, n28, or n66 for 5G NR is used. Note that band D is not limited thereto. For example, an LTE band may be used as band D.

Band E is an example of a fifth FDD band, a third TDD band, and a fourth TDD band, and is an FDD band (fifth FDD band) corresponding to the second power class, a TDD band (third TDD band) corresponding to the first power class, or a TDD band (fourth TDD band) corresponding to the second power class. As band E, a frequency band different from band B is used; for example, n12, n13, n40, or n41 for 5G NR is used. Note that band E is not limited thereto. For example, an LTE band may be used as band E.

The matching circuit (matching network) 41 is connected between the switch circuit 50 and the filters 31 and 36, thereby being able to achieve impedance matching between the switch circuit 50 and the filters 31 and 36. The matching circuit 41 may include, for example, an inductor and/or a capacitor (a so-called shunt inductor and/or a shunt capacitor) connected between the path connecting the switch circuit 50 and the filters 31 and 36 and ground. In addition, the matching circuit 41 may include, for example, an inductor and/or a capacitor (a so-called series inductor and/or a series capacitor) connected between the switch circuit 50 and the filters 31 and 36. Note that the matching element included in the matching circuit 41 is not limited to an inductor and/or a capacitor. Further, the matching circuit 41 need not necessarily be included in the radio-frequency module 1.

The matching circuit (matching network) 42 is connected between the switch circuit 50 and the filter 32, thereby being able to achieve impedance matching between the switch circuit 50 and the filter 32. The matching circuit 42 may include, for example, a shunt inductor and/or a shunt capacitor, and the matching circuit 42 may include a series inductor and/or a series capacitor. Note that the matching element included in the matching circuit 42 is not limited to an inductor and/or a capacitor. Further, the matching circuit 42 need not necessarily be included in the radio-frequency module 1.

The matching circuit (matching network) 43 is connected between the switch circuit 50 and the filter 33, thereby being able to achieve impedance matching between the switch circuit 50 and the filter 33. The matching circuit 43 may include, for example, a shunt inductor and/or a shunt capacitor, and may include a series inductor and/or a series capacitor. Note that the matching element included in the matching circuit 43 is not limited to an inductor and/or a capacitor. Further, the matching circuit 43 need not necessarily be included in the radio-frequency module 1.

The matching circuit (matching network) 44 is connected between the switch circuit 50 and the filter 34, thereby being able to achieve impedance matching between the switch circuit 50 and the filter 34. The matching circuit 44 may include, for example, a shunt inductor and/or a shunt capacitor, and may include a series inductor and/or a series capacitor. Note that the matching element included in the matching circuit 44 is not limited to an inductor and/or a capacitor. Further, the matching circuit 44 need not necessarily be included in the radio-frequency module 1.

The matching circuit (matching network) 45 is connected between the switch circuit 50 and the filter 35, thereby being able to achieve impedance matching between the switch circuit 50 and the filter 35. The matching circuit 45 may include, for example, a shunt inductor and/or a shunt capacitor, and may include a series inductor and/or a series capacitor. Note that the matching element included in the matching circuit 45 is not limited to an inductor and/or a capacitor. Further, the matching circuit 45 need not necessarily be included in the radio-frequency module 1.

The matching circuit (matching network) 46 is connected between the switch circuit 51 and the power amplifier 11, thereby being able to achieve impedance matching between the switch circuit 51 and the power amplifier 11. The matching circuit 46 may include, for example, a shunt inductor and/or a shunt capacitor, and may include a series inductor and/or a series capacitor. Note that the matching element included in the matching circuit 46 is not limited to an inductor and/or a capacitor. Further, the matching circuit 46 need not necessarily be included in the radio-frequency module 1.

The switch circuit 50 is connected between the antenna connection terminal 100 and the filters 31 to 36. Specifically, the switch circuit 50 includes a common terminal 500 and selection terminals 501, 502, 503, 504, and 505. The common terminal 500 is connected to the antenna connection terminal 100. The selection terminal 501 is connected to the filters 31 and 36 with the matching circuit 41 interposed therebetween. The selection terminal 502 is connected to the filter 32 with the matching circuit 42 interposed therebetween. The selection terminal 503 is connected to the filter 33 with the matching circuit 43 interposed therebetween. The selection terminal 504 is connected to the filter 34 with the matching circuit 44 interposed therebetween. The selection terminal 505 is connected to the filter 35 with the matching circuit 45 interposed therebetween.

In such a connection configuration, the switch circuit 50 may exclusively connect the common terminal 500 to the selection terminals 501 to 505, for example, based on a digital control signal from the RFIC 3. That is, in the switch circuit 50, the common terminal 500 is selectively connected to the selection terminals 501 to 505. The switch circuit 50 is composed of, for example, an SP5T-type switch circuit. Note that the switch circuit 50 need not necessarily be included in the radio-frequency module 1.

The switch circuit 51 is an example of a first switch circuit and is connected between the filters 31 to 35 and the power amplifier 11. Specifically, the switch circuit 51 includes a common terminal 510 and selection terminals 511, 512, 513, 514, and 515. The common terminal 510 is an example of a first common terminal and is connected to the power amplifier 11 with the matching circuit 46 interposed therebetween. The selection terminal 511 is an example of a first selection terminal and is connected to the filter 31. The selection terminal 512 is an example of a second selection terminal and is connected to the filter 32. The selection terminal 513 is an example of a third selection terminal and is connected to the filter 33. The selection terminal 514 is an example of a fourth selection terminal and is connected to the filter 34. The selection terminal 515 is an example of a fifth selection terminal and is connected to the filter 35.

In such a connection configuration, the switch circuit 51 may exclusively connect the common terminal 510 to the selection terminals 511 to 515, for example, based on a digital control signal from the RFIC 3. That is, in the switch circuit 51, the common terminal 510 is selectively connected to the selection terminals 511 to 515. The switch circuit 51 is composed of, for example, an SP5T-type switch circuit. Note that the switch circuit 51 need not necessarily be included in the radio-frequency module 1. In this case, the radio-frequency module 1 may further be equipped with at least one power amplifier.

### 1.3 Implementation Example of Radio-Frequency Module 1

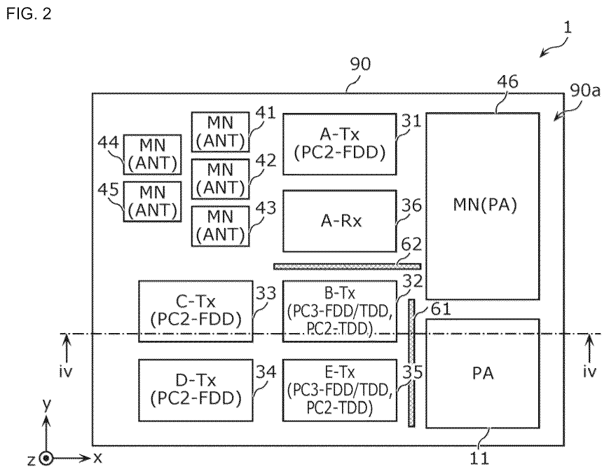

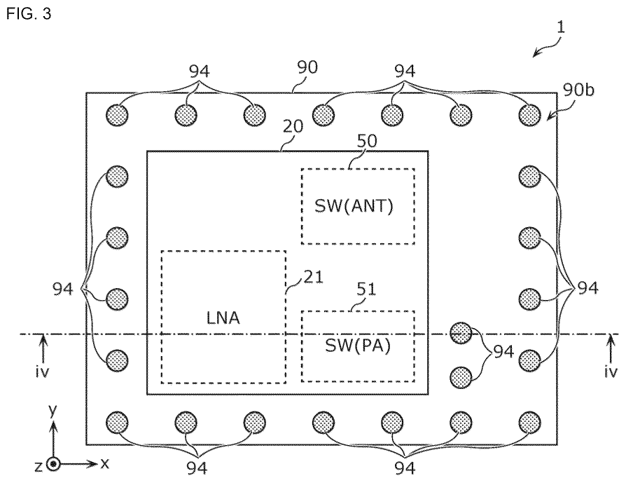

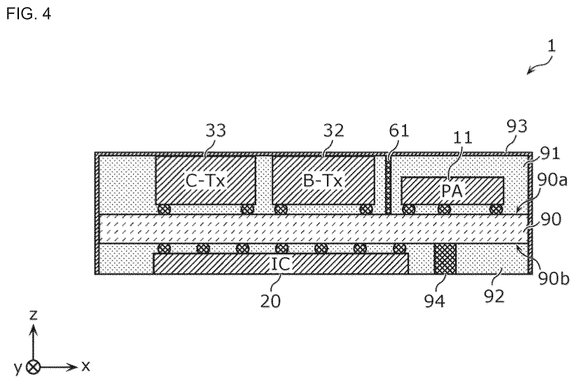

Next, an implementation example of the radio-frequency module 1 having a circuit configuration as described above will be described with reference to FIGS. 2 to 4. FIG. 2 is a plan view of the radio-frequency module 1 according to the present embodiment. FIG. 3 is a plan view of the radio-frequency module 1 according to the present embodiment, and is a view seen through a module substrate 90 from the positive side of the z-axis toward a principal surface 90b side of the module substrate 90. FIG. 4 is a cross-sectional view of the radio-frequency module 1 according to the present embodiment. A cross section of the radio-frequency module 1 in FIG. 4 is taken along line iv-iv in FIGS. 2 and 3.

In FIGS. 2 to 4, in order to facilitate understanding of arrangement relationships of respective components, some of the components are provided with labels (e.g., “PA”) representing the components; however, the labels need not necessarily be provided on actual components. Additionally, in FIGS. 2 and 3, illustration of resin members 91 and 92 (also referred to as an encapsulant) covering multiple circuit components and a metal shield 93 covering the resin members 91 and 92 is omitted.

Note that FIGS. 2 to 4 illustrate one implementation example of the radio-frequency module 1, and the radio-frequency module 1 may be implemented using any of various circuit implementations and circuit technologies. Accordingly, the description of the radio-frequency module 1 provided below is not to be construed as limiting.

The radio-frequency module 1 further includes, in addition to the circuit components illustrated in FIG. 1, metal members 61 and 62 (also referred to herein as a metal partition), the module substrate 90, the resin members 91 and 92, the metal shield 93, and multiple external connection terminals 94.

The module substrate 90 has the principal surfaces 90a and 90b facing each other. The principal surface 90a is an example of a first principal surface, and may also be referred to as an upper surface or a front surface. The principal surface 90b is an example of a second principal surface, and may also be referred to as a lower surface or a back surface. Wiring, via conductors, and the like are formed in the module substrate 90 and on the principal surfaces 90a and 90b; however, illustration thereof is omitted.

As the module substrate 90, for example, a low-temperature co-fired ceramics (LTCC) substrate or a high-temperature co-fired ceramics (HTCC) substrate having a multilayer structure of multiple dielectric layers, a component-embedded substrate, a substrate having a redistribution layer (RDL), or a printed circuit board can be used; however, the module substrate 90 is not limited thereto.

The resin member 91 covers at least a portion of the principal surface 90a of the module substrate 90 and circuit components on the principal surface 90a. Note that the resin member 91 does not cover at least a portion of the top surface of each of the filters 31 to 36, and the top surface of each of the filters 31 to 36 is exposed from the resin member 91 and is in contact with the metal shield 93. As a material of the resin member 91, for example, an epoxy resin can be used; however, the material is not limited thereto. The resin member 91 has a function of ensuring reliability such as mechanical strength and moisture resistance of the circuit components on the principal surface 90a. Note that the resin member 91 need not necessarily be included in the radio-frequency module 1.

The resin member 92 covers at least a portion of the principal surface 90b of the module substrate 90 and circuit components on the principal surface 90b. Note that the resin member 92 need not cover at least a portion of the top surface of an integrated circuit 20. That is, at least a portion of the top surface of the integrated circuit 20 may be exposed from the resin member 92. As a material of the resin member 92, for example, an epoxy resin can be used; however, the material is not limited thereto. The resin member 92 has a function of ensuring reliability such as mechanical strength and moisture resistance of the circuit components on the principal surface 90b. Note that the resin member 92 need not necessarily be included in the radio-frequency module 1.

The metal shield 93 is, for example, a metal thin film formed by a sputtering method. As illustrated in FIG. 4, the metal shield 93 covers the surfaces of the resin members 91 and 92. The metal shield 93 also covers the top surfaces of the filters 31 to 36. The metal shield 93 is connected to ground and can suppress entry of external noise into the radio-frequency module 1 and interference of noise generated in the radio-frequency module 1 with other modules or devices.

The external connection terminals 94 are disposed on the principal surface 90b of the module substrate 90. The external connection terminals 94 include the antenna connection terminal 100, the radio-frequency input terminal 111, and the radio-frequency output terminal 121 illustrated in FIG. 1. The external connection terminals 94 further include ground terminals connected to ground. The external connection terminals 94 are electrically connected to input/output terminals and/or a ground terminal on a mother board disposed in the negative direction of the z-axis of the radio-frequency module 1. As the external connection terminals 94, copper electrodes or solder electrodes can be used; however, the external connection terminals 94 are not limited thereto.

Here, referring to FIGS. 2 to 4, components disposed on the principal surfaces 90a and 90b of the module substrate 90 will be described.

The power amplifier 11 (PA) is disposed on the principal surface 90a of the module substrate 90. The power amplifier 11 can be configured with a heterojunction bipolar transistor (HBT), and can be manufactured using a semiconductor material. As the semiconductor material, for example, silicon germanium (SiGe) or gallium arsenide (GaAs) can be used. Note that the amplification transistor of the power amplifier 11 is not limited to an HBT. For example, the power amplifier 11 may be configured with an HEMT (High Electron Mobility Transistor) or a MESFET (Metal-Semiconductor Field Effect Transistor). In this case, as the semiconductor material, gallium nitride (GaN) or silicon carbide (SiC) may be used.

The filter 31 (A-Tx (PC2-FDD)) is disposed on the principal surface 90a of the module substrate 90. In a plan view of the module substrate 90, the filter 31 is disposed farther from the power amplifier 11 than the filters 32, 35, and 36. That is, the distance between the filter 31 and the power amplifier 11 is longer than the distance between each of the filters 32, 35, and 36 and the power amplifier 11. Additionally, in a plan view of the module substrate 90, the filter 31 is closer to the outer edge of the module substrate 90 than the filter 36. That is, the distance between the filter 31 and the outer edge of the module substrate 90 is shorter than the distance between the filter 36 and the outer edge of the module substrate 90.

The filter 32 (B-Tx (PC3-FDD/TDD, PC2-TDD)) is disposed on the principal surface 90a of the module substrate 90. In a plan view of the module substrate 90, the filter 32 is disposed between the power amplifier 11 and the filters 31, 33, 34, and 36.

The filter 33 (C-Tx (PC2-FDD)) is disposed on the principal surface 90a of the module substrate 90. In a plan view of the module substrate 90, the filter 33 is farther from the power amplifier 11 than the filters 32 and 35. That is, the distance between the filter 33 and the power amplifier 11 is longer than the distance between each of the filters 32 and 35 and the power amplifier 11.

The filter 34 (D-Tx (PC2-FDD)) is disposed on the principal surface 90a of the module substrate 90. In a plan view of the module substrate 90, the filter 34 is farther from the power amplifier 11 than the filters 32 and 35. That is, the distance between the filter 34 and the power amplifier 11 is longer than the distance between each of the filters 32 and 35 and the power amplifier 11.

The filter 35 (E-Tx (PC3-FDD/TDD, PC2-TDD)) is disposed on the principal surface 90a of the module substrate 90. In a plan view of the module substrate 90, the filter 35 is disposed between the power amplifier 11 and the filters 31, 33, 34, and 36.

The filter 36 (A-Rx) is disposed on the principal surface 90a of the module substrate 90. In a plan view of the module substrate 90, the filter 36 is disposed between the power amplifier 11 and the filter 31.

The top surface of each of the filters 31 to 36 is exposed from the resin member 91 and is in contact with the metal shield 93. Note that part or all of the filters 31 to 36 need not necessarily be in contact with the metal shield 93. Additionally, only a portion of the top surface may be in contact with the metal shield 93.

The filters 31 to 36 are implemented as surface acoustic wave (SAW) filters, bulk acoustic wave (BAW) filters, LC resonance filters, dielectric resonance filters, or any combination thereof. For example, the filters 31, 33, and 34 may be BAW filters having a higher power handling capability, and the rest of the filters may be SAW filters. Note that the filters 31 to 36 are not limited thereto.

The matching circuits 41 to 45 (MN (ANT)) and the matching circuit 46 (MN (PA)) are disposed on the principal surface 90a of the module substrate 90 and are implemented, for example, as chip inductors and/or chip capacitors. A chip inductor and/or a chip capacitor refers to a surface mount device (SMD) that constitutes an inductor and/or a capacitor. Note that the matching circuits 41 to 46 are not limited to chip inductors and/or chip capacitors. For example, part or all of the matching circuits 41 to 46 may be implemented by wiring patterns formed on the module substrate 90.

The metal member 61 is a shield wall erected on the principal surface 90a of the module substrate 90, and a tip thereof is connected to the metal shield 93. In a plan view of the module substrate 90, the metal member 61 is disposed between the power amplifier 11 and the filters 31, 33, 34, and 36. Note that the metal member 61 is not limited to a metal wall or a metal plate. For example, the metal member 61 may be constituted by multiple bonding wires or multiple post electrodes.

The metal member 62 is a shield wall erected on the principal surface 90a of the module substrate 90, and a tip thereof is connected to the metal shield 93. In a plan view of the module substrate 90, the metal member 62 is disposed between the power amplifier 11 and the filters 31 and 36. Note that the metal member 62 is not limited to a metal wall or a metal plate. For example, the metal member 62 may be constituted by multiple bonding wires or multiple post electrodes.

The integrated circuit 20 (IC) is disposed on the principal surface 90b of the module substrate 90, and includes the low-noise amplifier 21 and the switch circuits 50 and 51. The control circuitry, switch circuits, amplifiers, and other hardware-based elements described herein are implemented via physical computing and circuit architecture. The functionality of these elements may be achieved using hardwired logic circuitry, application-specific integrated circuits (ASICs), field-programmable gate arrays (FPGAs), or one or more programmable processors executing instructions stored in a non-transitory computer-readable memory. The spatial arrangements and circuit configurations described herein represent concrete improvements in hardware design, specifically, the mitigation of localized thermal loads on a module substrate through physical component placement. The integrated circuit 20 can be manufactured using a semiconductor material. As the semiconductor material, for example, monocrystalline silicon, gallium nitride (GaN), silicon carbide (SiC), or the like can be used.

The low-noise amplifier 21 (LNA), the switch circuit 50 (SW (ANT)), and the switch circuit 51 (SW (PA)) can be constituted by field-effect transistors (FETs). Note that the amplification transistor of the low-noise amplifier 21 and the respective switches included in the switch circuits 50 and 51 are not limited to FETs. For example, part or all of the low-noise amplifier 21 and the switch circuits 50 and 51 may be constituted by bipolar transistors.

Note that the low-noise amplifier 21 and the switch circuits 50 and 51 need not necessarily be included in a single integrated circuit. For example, the low-noise amplifier 21 may be included in an integrated circuit different from that of the switch circuits 50 and 51. In this case, the switch circuit 51 may be included in the same integrated circuit as a control circuit for controlling the power amplifier 11.

Note that the implementation of the radio-frequency module 1 is not limited to the implementation example illustrated in FIGS. 2 to 4. For example, the radio-frequency module 1 may be implemented on one surface of the module substrate 90 instead of both surfaces thereof.

### 1.4 Configuration of Filters 31, 33, and 34

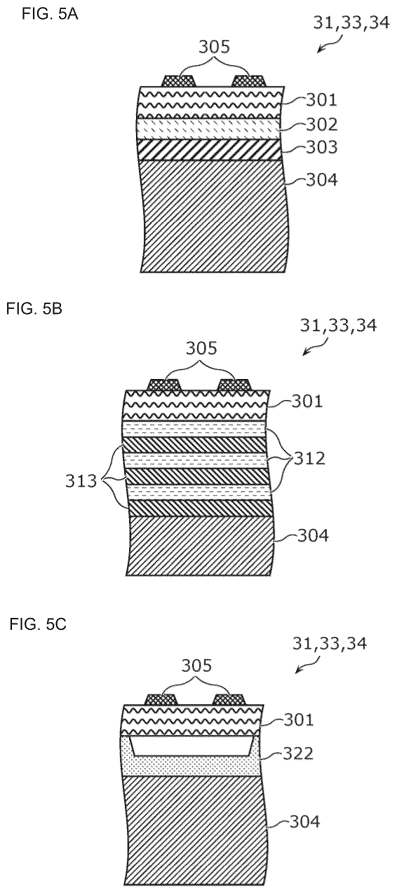

Next, some examples of the configuration of the filters 31, 33, and 34 will be described with reference to FIGS. 5A to 5C. Each of FIGS. 5A to 5C is a partial cross-sectional view of the filters 31, 33 and 34 according to the present embodiment.

Note that each of FIGS. 5A to 5C illustrates an exemplary configuration, and the filters 31, 33, and 34 may be implemented using any of various circuit implementations and circuit technologies. Accordingly, the description of the filters 31, 33, and 34 provided below is not to be construed as limiting.

In the example of FIG. 5A, each of the filters 31, 33, and 34 is a SAW filter and includes a piezoelectric layer 301, a low-acoustic-velocity layer 302, a high-acoustic-velocity layer 303, a support substrate 304, and an IDT (interdigital transducer) electrode 305.

The piezoelectric layer 301 is a layer having piezoelectric properties laminated on the low-acoustic-velocity layer 302, and is capable of propagating a surface acoustic wave. The IDT electrode 305 is disposed on the piezoelectric layer 301. As a material of the piezoelectric layer 301, for example, a piezoelectric single crystal or piezoelectric ceramics of lithium tantalate (LiTaO₃), lithium niobate (LiNbO₃), aluminum nitride, or zinc oxide can be used. Note that the material of the piezoelectric layer 301 is not limited thereto.

The low-acoustic-velocity layer 302 is laminated on the high-acoustic-velocity layer 303 and is disposed between the piezoelectric layer 301 and the high-acoustic-velocity layer 303. The acoustic velocity of a bulk wave propagating through the low-acoustic-velocity layer 302 is lower than the acoustic velocity of an elastic wave such as a surface wave or a boundary wave propagating through the piezoelectric layer 301. As a material of the low-acoustic-velocity layer 302, for example, a dielectric such as silicon dioxide, glass, silicon oxynitride, lithium oxide, tantalum oxide, a compound obtained by adding fluorine, carbon, or boron to silicon oxide, or any combination thereof can be used. Note that the material of the low-acoustic-velocity layer 302 is not limited thereto.

The high-acoustic-velocity layer 303 is laminated on the support substrate 304 and is disposed between the low-acoustic-velocity layer 302 and the support substrate 304.

The high-acoustic-velocity layer 303 is capable of confining a surface acoustic wave generated by a resonator to a portion where the piezoelectric layer 301 and the low-acoustic-velocity layer 302 are laminated, thereby preventing the surface acoustic wave from leaking to layers below the high-acoustic-velocity layer 303. The acoustic velocity of a bulk wave propagating through the high-acoustic-velocity layer 303 is higher than the acoustic velocity of an elastic wave such as a surface wave or a boundary wave propagating through the piezoelectric layer 301. As a material of the high-acoustic-velocity layer 303, for example, the following can be used: a piezoelectric material such as silicon nitride, aluminum nitride, lithium tantalate, lithium niobate, or quartz; a ceramic such as alumina, sapphire, magnesia, silicon carbide, zirconia, cordierite, mullite, steatite, or forsterite; a dielectric such as diamond or glass; a semiconductor such as silicon or gallium nitride; a resin; or any combination thereof. Note that the material of the high-acoustic-velocity layer 303 is not limited thereto.

The support substrate 304 is capable of supporting the high-acoustic-velocity layer 303, the low-acoustic-velocity layer 302, and the piezoelectric layer 301. As a material of the support substrate 304, a semiconductor material (a so-called wide bandgap material) having a bandgap larger than that of silicon (Si) or an insulating material is used. Specifically, as the wide bandgap material for the support substrate 304, for example, silicon carbide (SiC), gallium nitride (GaN), gallium oxide (Ga₂O₃), diamond, aluminum nitride (AlN), sapphire, or any combination thereof can be used. Additionally, as the insulating material for the support substrate 304, for example, spinel (MgAl₂O₄), yttrium aluminum garnet (Y₃Al₅O₁₂), quartz, mullite (3Al₂O₃2SiO₂ or 2Al₂O₃SiO₂), SiAlON, or any combination thereof can be used. Note that the material of the support substrate 304 is not limited thereto. A semiconductor material having a bandgap larger than that of silicon may suppress thermally-induced carrier generation at elevated temperatures, thereby maintaining high resistivity and preventing degradation of filter insertion loss and isolation characteristics at the operating temperatures encountered in high-power-class applications.

The IDT electrode 305 is disposed on the piezoelectric layer 301 and is capable of converting an electrical signal into a surface acoustic wave and vice versa. As a material of the IDT electrode 305, for example, aluminum, titanium, gold, silver, copper, platinum, tungsten, molybdenum, ruthenium, or any combination thereof can be used. Note that the material of the IDT electrode 305 is not limited thereto.

In the example of FIG. 5B, each of the filters 31, 33, and 34 includes the piezoelectric layer 301, low-acoustic-impedance layers 312, high-acoustic-impedance layers 313, the support substrate 304, and the IDT electrode 305.

The low-acoustic-impedance layers 312 and the high-acoustic-impedance layers 313 form an acoustic multilayer film in which the layers are alternately laminated on the support substrate 304. Note that the number of laminated layers of the low-acoustic-impedance layers 312 and the high-acoustic-impedance layers 313 is not limited to the example of FIG. 5B.

The low-acoustic-impedance layers 312 have a lower intrinsic acoustic impedance than that of the high-acoustic-impedance layers 313. As a material of the low-acoustic-impedance layers 312, for example, silicon oxide (SiO₂), aluminum nitride (AlN), or any combination thereof can be used. Note that the material of the low-acoustic-impedance layers 312 is not limited thereto.

The high-acoustic-impedance layers 313 have a higher intrinsic acoustic impedance than that of the low-acoustic-impedance layers 312. As a material of the high-acoustic-impedance layers 313, for example, tungsten (W), molybdenum (Mo), tantalum oxide (Ta₂O₅), zinc oxide (ZnO), or any combination thereof can be used. Note that the material of the high-acoustic-impedance layers 313 is not limited thereto.

In the example of FIG. 5C, each of the filters 31, 33, and 34 includes the piezoelectric layer 301, an intermediate layer 322, the support substrate 304, and the IDT electrode 305.

The intermediate layer 322 is laminated on the support substrate 304 and forms a cavity below the piezoelectric layer 301. Accordingly, the IDT electrode 305 and the piezoelectric layer 301 function as a laterally excited bulk acoustic resonator (XBAR). Note that the intermediate layer 322 may be integrated with the support substrate 304.

### 1.5 Conclusion

As described above, the radio-frequency module 1 according to the present embodiment includes: the module substrate 90; the power amplifier 11 disposed on the module substrate 90; the filter 31 disposed on the module substrate 90, having a passband that includes the transmission band of the first FDD band (band A) corresponding to the first power class, and connected to the power amplifier 11; the filter 32 disposed on the module substrate 90, and having a passband that includes the transmission band of the second FDD band (band B) corresponding to the second power class defined by a maximum output power lower than that of the first power class, the first TDD band (band B) corresponding to the first power class, or the second TDD band (band B) corresponding to the second power class, wherein, in a plan view of the module substrate 90, the filter 32 is disposed between the power amplifier 11 and the filter 31.

Accordingly, heat transfer from the power amplifier 11 to the filter 31 is reduced by the filter 32 disposed between the power amplifier 11 and the filter 31. Therefore, deterioration of characteristics of the filter 31 due to an increase in temperature of the filter 31 caused by heat generated in the power amplifier 11 may be suppressed. In particular, in the filter 31 for the first FDD band corresponding to the first power class that allows higher maximum output power, the amount of heat generation is greater and the temperature is more likely to increase than in the filter 32 for the second FDD band corresponding to the second power class, the first TDD band corresponding to the first power class, or the second TDD band corresponding to the second power class. Therefore, the effect of suppressing characteristic deterioration of the filter 31 by reducing heat transfer from the power amplifier 11 to the filter 31 is significant. In other words, the filter 32 disposed between the power amplifier 11 and the filter 31 acts as a thermal buffer, reducing the amount of heat transferred from the power amplifier 11 to the filter 31.

Additionally, for example, the radio-frequency module 1 according to the present embodiment may further include the switch circuit 51 disposed on the module substrate 90 and including the common terminal 510 connected to the output end of the power amplifier 11, the selection terminal 511 connected to the filter 31, and the selection terminal 512 connected to the filter 32.

Accordingly, the filters 31 and 32 can be selectively connected to the power amplifier 11. Therefore, when the filter 31 is connected to the power amplifier 11, the filter 32 is not connected to the power amplifier 11, thereby further reducing heat transfer from the power amplifier 11 to the filter 31.

Additionally, for example, the radio-frequency module 1 according to the present embodiment may further include the filter 33 disposed on the module substrate 90 and having a passband that includes the transmission band of the third FDD band corresponding to the first power class. The switch circuit 51 may further include the selection terminal 513 connected to the filter 33, and, in a plan view of the module substrate 90, the filter 32 may be disposed between the power amplifier 11 and the filter 33.

Accordingly, heat transfer from the power amplifier 11 to the filter 33 is also reduced by the filter 32 disposed between the power amplifier 11 and the filter 33. Therefore, it is possible to suppress deterioration of characteristics of the filter 33 due to an increase in temperature of the filter 33 caused by heat generated in the power amplifier 11. In particular, in the filter 33 for the third FDD band corresponding to the first power class that allows higher maximum output power, the amount of heat generation is greater and the temperature is more likely to increase than in the filter 32 for the second FDD band corresponding to the second power class, the first TDD band corresponding to the first power class, or the second TDD band corresponding to the second power class. Therefore, the effect of suppressing characteristic deterioration of the filter 33 by reducing heat transfer from the power amplifier 11 to the filter 33 is significant.

Additionally, for example, the radio-frequency module 1 according to the present embodiment may further include the filter 34 disposed on the module substrate 90 and having a passband that includes the transmission band of the fourth FDD band corresponding to the first power class. The switch circuit 51 may further include the selection terminal 514 connected to the filter 34, and, in a plan view of the module substrate 90, the filter 32 may be disposed between the power amplifier 11 and the filter 34.

Accordingly, heat transfer from the power amplifier 11 to the filter 34 is also reduced by the filter 32 disposed between the power amplifier 11 and the filter 34. Therefore, it is possible to suppress deterioration of characteristics of the filter 34 due to an increase in temperature of the filter 34 caused by heat generated in the power amplifier 11. In particular, in the filter 34 for the fourth FDD band corresponding to the first power class that allows higher maximum output power, the amount of heat generation is greater and the temperature is more likely to increase than in the filter 32 for the second FDD band corresponding to the second power class, the first TDD band corresponding to the first power class, or the second TDD band corresponding to the second power class. Therefore, the effect of suppressing characteristic deterioration of the filter 34 by reducing heat transfer from the power amplifier 11 to the filter 34 is significant.

Additionally, for example, the radio-frequency module 1 according to the present embodiment may further include the filter 35 disposed on the module substrate 90 and having a passband that includes the transmission band of the fifth FDD band corresponding to the second power class, the third TDD band corresponding to the first power class, or the fourth TDD band corresponding to the second power class. The switch circuit 51 may further include the selection terminal 515 connected to the filter 35, and, in a plan view of the module substrate 90, the filter 35 may be disposed between the power amplifier 11 and the filter 31.

Accordingly, heat transfer from the power amplifier 11 to the filter 31 is also reduced by the filter 35 in addition to the filter 32. Therefore, it is possible to further suppress deterioration of characteristics of the filter 31 due to an increase in temperature of the filter 31 caused by heat generated in the power amplifier 11.

Further, for example, the radio-frequency module 1 according to the present embodiment may further include the low-noise amplifier 21 disposed on the module substrate 90, and the filter 36 disposed on the module substrate 90, having a passband that includes the reception band of the first FDD band, and connected to the low-noise amplifier 21. In a plan view of the module substrate 90, the filter 32 may be disposed between the power amplifier 11 and the filter 36.

Accordingly, heat transfer from the power amplifier 11 to the filter 36 is reduced by the filter 32 disposed between the power amplifier 11 and the filter 36. Therefore, it is possible to suppress deterioration of characteristics of the filter 36 due to an increase in temperature of the filter 36 caused by heat generated in the power amplifier 11.

Further, for example, in the radio-frequency module 1 according to the present embodiment, in a plan view of the module substrate 90, the filter 36 may be disposed between the power amplifier 11 and the filter 31.

Accordingly, heat transfer from the power amplifier 11 to the filter 31 is also reduced by the filter 36 in addition to the filter 32. Therefore, it is possible to further suppress deterioration of characteristics of the filter 31 due to an increase in temperature of the filter 31 caused by heat generated in the power amplifier 11.

Further, for example, in the radio-frequency module 1 according to the present embodiment, in a plan view of the module substrate 90, the filter 31 may be closer to an outer edge of the module substrate 90 than the filter 36.

Accordingly, since the filter 31 is disposed closer to the outer edge of the module substrate 90, heat dissipation from the filter 31 to the outside of the radio-frequency module 1 increases. Therefore, it is possible to further suppress deterioration of characteristics of the filter 31 due to an increase in temperature of the filter 31.

Additionally, for example, the radio-frequency module 1 according to the present embodiment may further include the metal member 61 and/or 62 disposed between the power amplifier 11 and the filter 31 in a plan view of the module substrate 90.

Accordingly, heat transfer from the power amplifier 11 to the filter 31 is reduced by the metal member 61 and/or 62 disposed between the power amplifier 11 and the filter 31. Therefore, it is possible to further suppress deterioration of characteristics of the filter 31 due to an increase in temperature of the filter 31 caused by heat generated in the power amplifier 11.

Additionally, for example, in the radio-frequency module 1 according to the present embodiment, the module substrate 90 may have the principal surfaces 90a and 90b facing each other. The power amplifier 11, the filter 31, and the filter 32 may be disposed on the principal surface 90a. The radio-frequency module 1 may further include the multiple external connection terminals 94 disposed on the principal surface 90b, the resin member 91 disposed on the principal surface 90a and covering at least a portion of the power amplifier 11, the filter 31, and the filter 32, and the metal shield 93 covering at least a portion of a surface of the resin member 91. At least a portion of the filter 32 may be in contact with the metal shield 93.

Accordingly, heat dissipation from the filter 32 to the outside of the radio-frequency module 1 increases. Therefore, heat transfer from the power amplifier 11 to the filter 31 via the filter 32 is further reduced, and deterioration of characteristics of the filter 31 can be further suppressed.

Further, for example, in the radio-frequency module 1 according to the present embodiment, the filter 31 may be a surface acoustic wave filter including the piezoelectric layer 301 and the support substrate 304, and the support substrate 304 may be formed of a semiconductor material having a bandgap larger than that of silicon or an insulating material.

Accordingly, the support substrate 304 formed of a semiconductor material having a bandgap larger than that of silicon or an insulating material can suppress a decrease in resistance due to a temperature rise, and in particular can increase a temperature at which the resistance starts to decrease compared to a silicon substrate. Therefore, the filter 31 can suppress deterioration of characteristics at high temperatures, as compared with a silicon substrate, because of the support substrate 304 formed of a semiconductor material having a bandgap larger than that of silicon or an insulating material. In particular, since the temperature of the filter 31 for the first FDD band corresponding to the first power class that allows higher maximum output power is likely to increase, the effect of suppressing deterioration of characteristics at high temperatures is significant.

Further, for example, in the radio-frequency module 1 according to the present embodiment, the filter 31 may be a surface acoustic wave filter including the piezoelectric layer 301 and the support substrate 304. The support substrate 304 may be formed of at least one selected from silicon carbide (SiC), gallium nitride (GaN), gallium oxide (Ga₂O₃), diamond, aluminum nitride (AlN), sapphire, spinel (MgAl₂O₄), yttrium aluminum garnet (Y₃Al₅O₁₂), quartz, mullite (3Al₂O₃2SiO₂ or 2Al₂O₃SiO₂), and SiAlON.

Accordingly, the support substrate 304 formed of the above-mentioned semiconductor material or the above-mentioned insulating material can suppress a decrease in resistance due to a temperature rise, and in particular can increase a temperature at which the resistance starts to decrease compared to a silicon substrate. Therefore, the filter 31 can suppress deterioration of characteristics at high temperatures, as compared with a silicon substrate, because of the support substrate 304 formed of the above-mentioned semiconductor material or the above-mentioned insulating material. In particular, since the temperature of the filter 31 for the first FDD band corresponding to the first power class that allows higher maximum output power is likely to increase, the effect of suppressing deterioration of characteristics at high temperatures is significant.

### Modification 1 of Embodiment 1

Next, Modification 1 of Embodiment 1 will be described. In the present modification, the arrangement of the filters 31 and 36 on the principal surface 90a of the module substrate 90 is mainly different from that in Embodiment 1. Hereinafter, the present modification will be described with reference to the drawings, focusing on differences from Embodiment 1. Note that the circuit configurations of the communication device 5 and the radio-frequency module 1 according to the present modification are the same as those of the communication device 5 and the radio-frequency module 1 according to Embodiment 1, and therefore illustration and description thereof are omitted.

### 1.6 Implementation Example of Radio-frequency Module 1

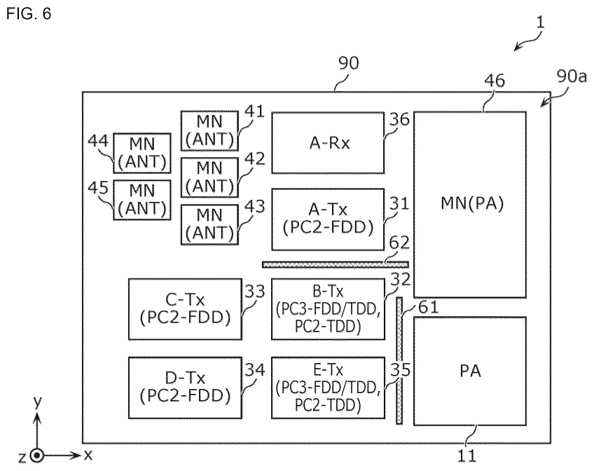

An implementation example of the radio-frequency module 1 according to the present modification will be described with reference to FIG. 6. FIG. 6 is a plan view of the radio-frequency module 1 according to the present modification. In FIG. 6, in order to facilitate understanding of arrangement relationships of respective components, some of the components are provided with labels (e.g., “PA”) representing the components; however, the labels need not necessarily be provided on actual components. Additionally, in FIG. 6, illustration of the resin members 91 and 92 covering multiple circuit components and the metal shield 93 covering the resin members 91 and 92 is omitted.

Note that FIG. 6 illustrates one implementation example of the radio-frequency module 1, and the radio-frequency module 1 may be implemented using any of various circuit implementations and circuit technologies. Accordingly, the description of the radio-frequency module 1 provided below is not to be construed as limiting.

As in Embodiment 1, in a plan view of the module substrate 90, the filters 32 and 35 are disposed between the power amplifier 11 and the filters 31, 33, 34, and 36. However, in the present modification, the positions of the filters 31 and 36 are interchanged. This allows the filter 31 to be disposed between the power amplifier 11 and the filter 36 in a plan view of the module substrate 90, and the filter 36 is closer to the outer edge of the module substrate 90 than the filter 31.

### 1.7 Conclusion

As described above, in the radio-frequency module 1 according to the present modification, the filter 31 may be disposed between the power amplifier 11 and the filter 36 in a plan view of the module substrate 90.

Accordingly, heat transfer from the power amplifier 11 to the filter 36 is also reduced by the filter 31 in addition to the filter 32. Therefore, it is possible to further suppress deterioration of characteristics of the filter 36 due to an increase in temperature of the filter 36 caused by heat generated in the power amplifier 11. This is particularly effective in improving the reception characteristics of signals in the first FDD band.

### Modification 2 of Embodiment 1

Next, Modification 2 of Embodiment 1 will be described. In the present modification, the arrangement of the filters 31 and 32 and the matching circuit 46 on the principal surface 90a of the module substrate 90 is mainly different from that in Embodiment 1. Hereinafter, the present modification will be described with reference to the drawings, focusing on differences from Embodiment 1.

### 1.8 Implementation Example of Radio-frequency Module 1

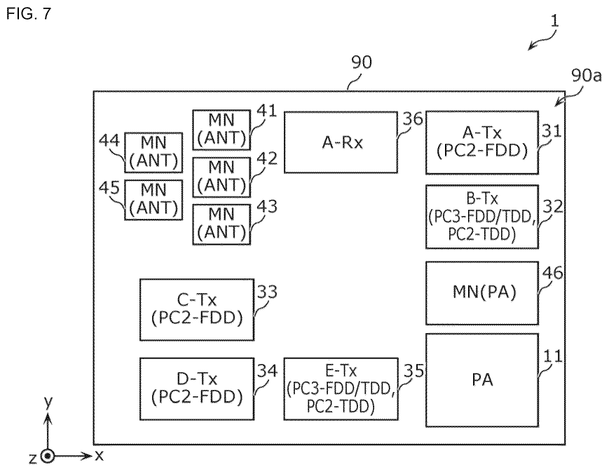

An implementation example of the radio-frequency module 1 according to the present modification will be described with reference to FIG. 7. FIG. 7 is a plan view of the radio-frequency module 1 according to the present modification. In FIG. 7, in order to facilitate understanding of arrangement relationships of respective components, some of the components are provided with labels (e.g., “PA”) representing the components; however, the labels need not necessarily be provided on actual components. Additionally, in FIG. 7, illustration of the resin members 91 and 92 covering multiple circuit components and the metal shield 93 covering the resin members 91 and 92 is omitted.

Note that FIG. 7 illustrates one implementation example of the radio-frequency module 1, and the radio-frequency module 1 may be implemented using any of various circuit implementations and circuit technologies. Accordingly, the description of the radio-frequency module 1 provided below is not to be construed as limiting.

As in Embodiment 1, in a plan view of the module substrate 90, the filter 32 is disposed between the power amplifier 11 and the filter 31. Further, in the present modification, the matching circuit 46 is also disposed between the power amplifier 11 and the filter 31 in a plan view of the module substrate 90.

### 1.9 Conclusion

As described above, the radio-frequency module 1 according to the present modification may further include the matching circuit 46 connected between the power amplifier 11 and the filter 31, and, in a plan view of the module substrate 90, disposed between the power amplifier 11 and the filter 31.

Accordingly, heat transfer from the power amplifier 11 to the filter 31 is also reduced by the matching circuit 46 in addition to the filter 32. Therefore, it is possible to further suppress deterioration of characteristics of the filter 31 due to an increase in temperature of the filter 31 caused by heat generated in the power amplifier 11.

### Embodiment 2

Next, Embodiment 2 will be described. In the present embodiment, the point that the filter for the reception of band B is included in the radio-frequency module instead of the filter for the reception of band A is mainly different from Embodiment 1. Hereinafter, a radio-frequency module 1A according to the present embodiment will be described with reference to the drawings.

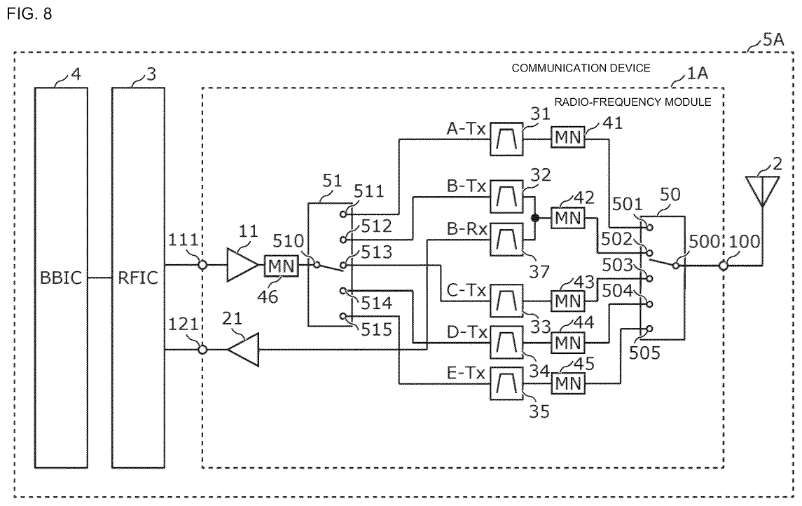

Note that a communication device 5A according to the present embodiment is the same as the communication device 5 except that it includes the radio-frequency module 1A instead of the radio-frequency module 1. Therefore, description of the circuit configuration of the communication device 5A is omitted, and the circuit configuration of the radio-frequency module 1A will be described with reference to FIG. 8. FIG. 8 is a circuit configuration diagram of the communication device 5A according to the present embodiment.

Note that FIG. 8 illustrates an exemplary circuit configuration, and the communication device 5A and the radio-frequency module 1A may be implemented using any of various circuit implementations and circuit technologies. Accordingly, the description of the radio-frequency module 1A provided below is not to be construed as limiting.

### 2.1 Circuit Configuration of Radio-frequency Module 1A

The radio-frequency module 1A includes the power amplifier 11, the low-noise amplifier 21, the filters 31, 32, 33, 34, 35, and 37, the matching circuits 41, 42, 43, 44, 45, and 46, the switch circuits 50 and 51, the antenna connection terminal 100, the radio-frequency input terminal 111, and the radio-frequency output terminal 121.

The filter 37 is an example of a seventh filter and has a passband that includes the reception band of band B. The filter 37 is connected between the antenna connection terminal 100 and the low-noise amplifier 21. Specifically, one of two ends of the filter 37 is switchably connected to the antenna connection terminal 100 with the matching circuit 42 and the switch circuit 50 interposed therebetween. In the meanwhile, the other end of the filter 37 is connected to the low-noise amplifier 21.

### 2.2 Implementation Example of Radio-frequency Module 1A

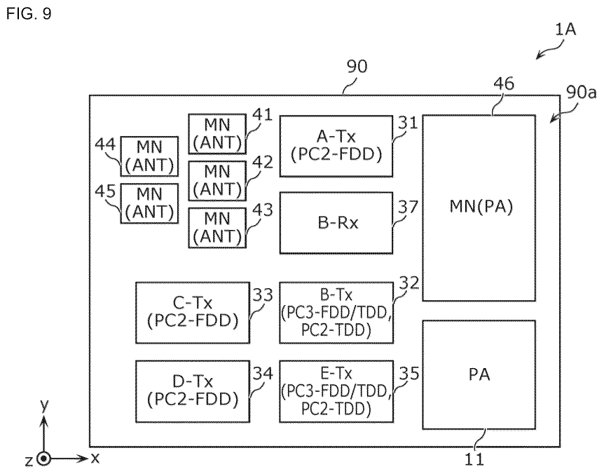

Next, an implementation example of the radio-frequency module 1A having a circuit configuration as described above will be described with reference to FIG. 9. FIG. 9 is a plan view of the radio-frequency module 1A according to the present embodiment.

In FIG. 9, in order to facilitate understanding of arrangement relationships of respective components, some of the components are provided with labels (e.g., “PA”) representing the components; however, the labels need not necessarily be provided on actual components. Additionally, in FIG. 9, illustration of the resin members 91 and 92 covering multiple circuit components and the metal shield 93 covering the resin members 91 and 92 is omitted.

Note that FIG. 9 illustrates one implementation example of the radio-frequency module 1A, and the radio-frequency module 1A may be implemented using any of various circuit implementations and circuit technologies. Accordingly, the description of the radio-frequency module 1A provided below is not to be construed as limiting.

The radio-frequency module 1A further includes, in addition to the circuit components illustrated in FIG. 8, the module substrate 90, the resin members 91 and 92, the metal shield 93, and the multiple external connection terminals 94.

The filter 37 (B-Rx) is disposed on the principal surface 90a of the module substrate 90. As in the filter 36 of Embodiment 1, in a plan view of the module substrate 90, the filter 37 is disposed between the power amplifier 11 and the filter 31. Note that, as in the filters 31 to 36, the filter 37 is implemented as a SAW filter, a BAW filter, an LC resonance filter, a dielectric resonance filter, or any combination thereof. Note that the filter 37 is not limited thereto.

Note that the implementation of the radio-frequency module 1A is not limited to the implementation example of FIG. 9. For example, the radio-frequency module 1A may be implemented on one surface of the module substrate 90 instead of both surfaces thereof.

### 2.3 Conclusion

As described above, in the radio-frequency module 1A according to the present embodiment, the passband of the filter 32 may include the transmission band of the second FDD band. The radio-frequency module 1A may further include the low-noise amplifier 21 disposed on the module substrate 90, and the filter 37 disposed on the module substrate 90, having a passband that includes the reception band of the second FDD band, and connected to the low-noise amplifier 21. In a plan view of the module substrate 90, the filter 37 may be disposed between the power amplifier 11 and the filter 31.

Accordingly, heat transfer from the power amplifier 11 to the filter 31 is also reduced by the filter 37 in addition to the filter 32. Therefore, it is possible to further suppress deterioration of characteristics of the filter 31 due to an increase in temperature of the filter 31 caused by heat generated in the power amplifier 11.

### Embodiment 3

Next, Embodiment 3 will be described. In the present embodiment, the point that two power amplifiers are included in the radio-frequency module is mainly different from Embodiment 1. Hereinafter, a radio-frequency module 1B according to the present embodiment will be described with reference to the drawings.

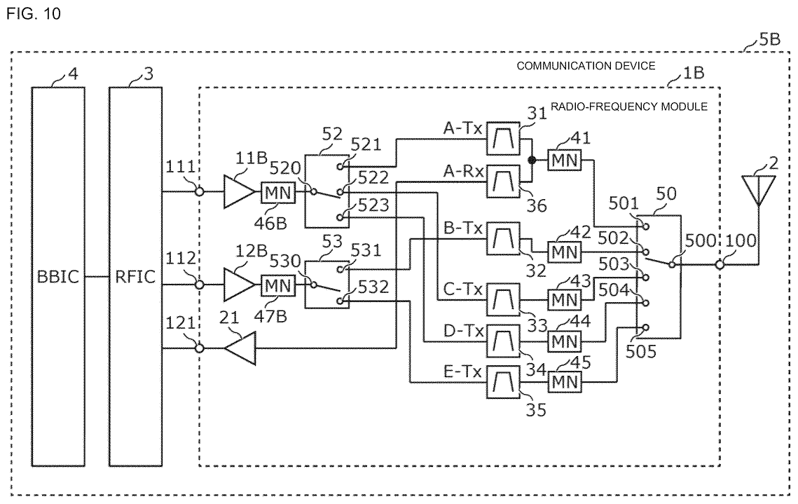

Note that a communication device 5B according to the present embodiment is the same as the communication device 5 except that it includes the radio-frequency module 1B instead of the radio-frequency module 1. Therefore, description of the circuit configuration of the communication device 5B is omitted, and the circuit configuration of the radio-frequency module 1B will be described with reference to FIG. 10. FIG. 10 is a circuit configuration diagram of the communication device 5B according to the present embodiment.

Note that FIG. 10 illustrates an exemplary circuit configuration, and the communication device 5B and the radio-frequency module 1B may be implemented using any of various circuit implementations and circuit technologies. Accordingly, the description of the radio-frequency module 1B provided below is not to be construed as limiting.

### 3.1 Circuit Configuration of Radio-frequency Module 1B

The radio-frequency module 1B includes power amplifiers 11B and 12B, the low-noise amplifier 21, the filters 31, 32, 33, 34, 35, and 36, the matching circuits 41, 42, 43, 44, 45, 46B, and 47B, the switch circuits 50, 52, and 53, the antenna connection terminal 100, the radio-frequency input terminals 111 and 112, and the radio-frequency output terminal 121.

The radio-frequency input terminals 111 and 112 are external connection terminals of the radio-frequency module 1B. The radio-frequency input terminals 111 and 112 are connected to the RFIC 3 outside the radio-frequency module 1B and respectively to the power amplifiers 11B and 12B inside the radio-frequency module 1B. This allows the radio-frequency module 1B to supply transmission signals supplied from the RFIC 3 via the radio-frequency input terminals 111 and 112 to the power amplifiers 11B and 12B, respectively.

The power amplifier 11B is an example of the first power amplifier and is connected between the radio-frequency input terminal 111 and the filters 31, 33, and 34. Specifically, an input end of the power amplifier 11B is connected to the radio-frequency input terminal 111. In the meanwhile, an output end of the power amplifier 11B is switchably connected to the filters 31, 33, and 34 with the matching circuit 46B and the switch circuit 52 interposed therebetween. The power amplifier 11B is capable of amplifying a transmission signal supplied from the RFIC 3 via the radio-frequency input terminal 111, using power supplied from the power source.

Note that part or all of the power amplifier 11B need not necessarily be included in the radio-frequency module 1B. In this case, part or all of the power amplifier 11B may be connected between the RFIC 3 and the radio-frequency input terminal 111, or may be included in the RFIC 3.

The power amplifier 12B is an example of a second power amplifier and is connected between the radio-frequency input terminal 112 and the filters 32 and 35. Specifically, an input end of the power amplifier 12B is connected to the radio-frequency input terminal 112. In the meanwhile, an output end of the power amplifier 12B is switchably connected to the filters 32 and 35 with the matching circuit 47B and the switch circuit 53 interposed therebetween. The power amplifier 12B is capable of amplifying a transmission signal supplied from the RFIC 3 via the radio-frequency input terminal 112, using power supplied from the power source.

Note that part or all of the power amplifier 12B need not necessarily be included in the radio-frequency module 1B. In this case, part or all of the power amplifier 12B may be connected between the RFIC 3 and the radio-frequency input terminal 112, or may be included in the RFIC 3.

The matching circuit (matching network) 46B is connected between the switch circuit 52 and the power amplifier 11B, thereby being able to achieve impedance matching between the switch circuit 52 and the power amplifier 11B. The matching circuit 46B may include, for example, a shunt inductor and/or a shunt capacitor, and may include a series inductor and/or a series capacitor. Note that the matching element included in the matching circuit 46B is not limited to an inductor and/or a capacitor. Further, the matching circuit 46B need not necessarily be included in the radio-frequency module 1B.

The matching circuit (matching network) 47B is connected between the switch circuit 53 and the power amplifier 12B, thereby being able to achieve impedance matching between the switch circuit 53 and the power amplifier 12B. The matching circuit 47B may include, for example, a shunt inductor and/or a shunt capacitor, and may include a series inductor and/or a series capacitor. Note that the matching element included in the matching circuit 47B is not limited to an inductor and/or a capacitor. Further, the matching circuit 47B need not necessarily be included in the radio-frequency module 1B.

The switch circuit 52 is an example of a second switch circuit and is connected between the filters 31, 33, and 34 and the power amplifier 11B. Specifically, the switch circuit 52 includes a common terminal 520 and selection terminals 521, 522, and 523. The common terminal 520 is an example of a second common terminal and is connected to the power amplifier 11B with the matching circuit 46B interposed therebetween. The selection terminal 521 is an example of a sixth selection terminal and is connected to the filter 31. The selection terminal 522 is an example of a seventh selection terminal and is connected to the filter 33. The selection terminal 523 is an example of an eighth selection terminal and is connected to the filter 34.

In such a connection configuration, the switch circuit 52 may exclusively connect the common terminal 520 to the selection terminals 521, 522, and 523, for example, based on a digital control signal from the RFIC 3. That is, in the switch circuit 52, the common terminal 520 is selectively connected to the selection terminals 521 to 523. The switch circuit 52 is composed of, for example, an SP3T-type switch circuit. Note that the switch circuit 52 need not necessarily be included in the radio-frequency module 1B.

The switch circuit 53 is an example of a third switch circuit and is connected between the filters 32 and 35 and the power amplifier 12B. Specifically, the switch circuit 53 includes a common terminal 530 and selection terminals 531 and 532. The common terminal 530 is an example of a third common terminal and is connected to the power amplifier 12B with the matching circuit 47B interposed therebetween. The selection terminal 531 is an example of a ninth selection terminal and is connected to the filter 32. The selection terminal 532 is an example of a tenth selection terminal and is connected to the filter 35.

In such a connection configuration, the switch circuit 53 may exclusively connect the common terminal 530 to the selection terminals 531 and 532, for example, based on a digital control signal from the RFIC 3. That is, in the switch circuit 53, the common terminal 530 is selectively connected to the selection terminals 531 and 532. The switch circuit 53 is composed of, for example, an SPDT-type switch circuit. Note that the switch circuit 53 need not necessarily be included in the radio-frequency module 1B.

### 3.2 Implementation Example of Radio-frequency Module 1B

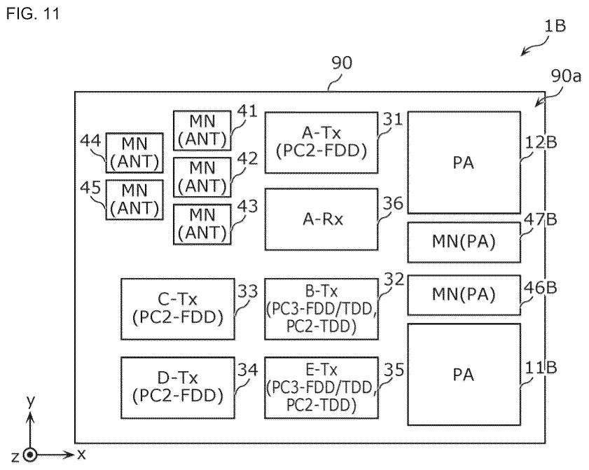

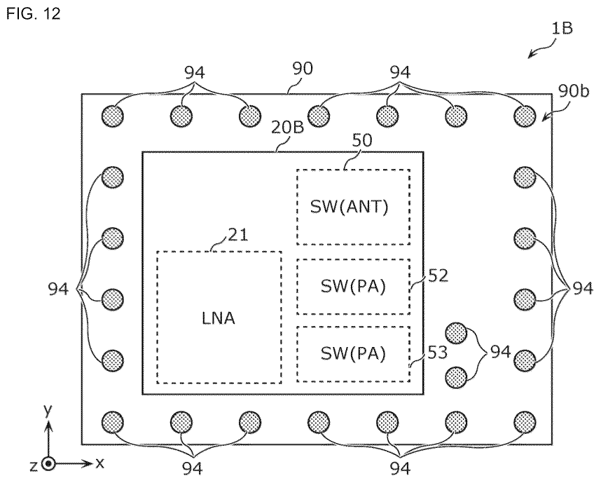

Next, an implementation example of the radio-frequency module 1B having a circuit configuration as described above will be described with reference to FIGS. 11 and 12. FIG. 11 is a plan view of the radio-frequency module 1B according to the present embodiment. FIG. 12 is a plan view of the radio-frequency module 1B according to the present embodiment, and is a view seen through the module substrate 90 from the positive side of the z-axis toward the principal surface 90b side of the module substrate 90.

In FIGS. 11 and 12, in order to facilitate understanding of arrangement relationships of respective components, some of the components are provided with labels (e.g., “PA”) representing the components; however, the labels need not necessarily be provided on actual components. Additionally, in FIGS. 11 and 12, illustration of the resin members 91 and 92 covering multiple circuit components and the metal shield 93 covering the resin members 91 and 92 is omitted.

Note that FIGS. 11 and 12 illustrate one implementation example of the radio-frequency module 1B, and the radio-frequency module 1B may be implemented using any of various circuit implementations and circuit technologies. Accordingly, the description of the radio-frequency module 1B provided below is not to be construed as limiting.

The power amplifiers 11B and 12B (PA) are disposed on the principal surface 90a of the module substrate 90. Each of the power amplifiers 11B and 12B may be configured with an HBT, an HEMT, a MESFET, or any combination thereof, as in the power amplifier 11 according to Embodiment 1.

The matching circuits 46B and 47B (MN (PA)) are disposed on the principal surface 90a of the module substrate 90 and, in a plan view of the module substrate 90, are disposed between the power amplifiers 11B and 12B. The matching circuits 46B and 47B may be implemented as, for example, chip inductors and/or chip capacitors. Note that the matching circuits 46B and 47B are not limited to chip inductors and/or chip capacitors. For example, part or all of the matching circuits 46B and 47B may be implemented by wiring patterns formed on the module substrate 90.

In a plan view of the module substrate 90, the filters 32 and 35 are disposed between the power amplifier 11B and the filters 31, 33, 34, and 36.

An integrated circuit 20B (IC) is disposed on the principal surface 90b of the module substrate 90, and includes the low-noise amplifier 21 and the switch circuits 50, 52, and 53. The integrated circuit 20B can be manufactured using a semiconductor material. As the semiconductor material, for example, monocrystalline silicon, gallium nitride (GaN), silicon carbide (SiC), or the like can be used. Note that the low-noise amplifier 21 and the switch circuits 50, 52, and 53 may be included in multiple integrated circuits.

### 3.3 Conclusion

As described above, the radio-frequency module 1B according to the present embodiment may further include the power amplifier 12B disposed on the module substrate 90 and connected to the filter 32.

Accordingly, in the radio-frequency module 1B in which a transmission signal in the first FDD band and a transmission signal in the second FDD band, the first TDD band, or the second TDD band can be amplified by the power amplifiers 11B and 12B, respectively, heat transfer from the power amplifier 11B to the filter 31 is reduced by the filter 32 disposed between the power amplifier 11B and the filter 31. Therefore, it is possible to suppress deterioration of characteristics of the filter 31 due to an increase in temperature of the filter 31 caused by heat generated in the power amplifier 11B.

Additionally, for example, the radio-frequency module 1B according to the present embodiment may further include the filter 33 disposed on the module substrate 90 and having a passband that includes the transmission band of the third FDD band corresponding to the first power class; and the switch circuit 52 disposed on the module substrate 90 and including the common terminal 520 connected to the output end of the power amplifier 11B, the selection terminal 521 connected to the filter 31, and the selection terminal 522 connected to the filter 33. In a plan view of the module substrate 90, the filter 32 may be disposed between the power amplifier 11B and the filter 33.

Accordingly, heat transfer from the power amplifier 11B to the filter 33 is also reduced by the filter 32 disposed between the power amplifier 11B and the filter 33. Therefore, it is possible to suppress deterioration of characteristics of the filter 33 due to an increase in temperature of the filter 33 caused by heat generated in the power amplifier 11B.

Further, for example, the radio-frequency module 1B according to the present embodiment may further include the filter 34 disposed on the module substrate 90 and having a passband that includes the transmission band of the fourth FDD band corresponding to the first power class. The switch circuit 52 may further include the selection terminal 523 connected to the filter 34, and, in a plan view of the module substrate 90, the filter 32 may be disposed between the power amplifier 11B and the filter 34.

Accordingly, heat transfer from the power amplifier 11B to the filter 34 is also reduced by the filter 32 disposed between the power amplifier 11B and the filter 34. Therefore, it is possible to suppress deterioration of characteristics of the filter 34 due to an increase in temperature of the filter 34 caused by heat generated in the power amplifier 11B.

Additionally, for example, the radio-frequency module 1B according to the present embodiment may further include the filter 35 disposed on the module substrate 90 and having a passband that includes the transmission band of the fifth FDD band corresponding to the second power class, the third TDD band corresponding to the first power class, or the fourth TDD band corresponding to the second power class; and the switch circuit 53 disposed on the module substrate 90 and including the common terminal 530 connected to the output end of the power amplifier 12B, the selection terminal 531 connected to the filter 32, and the selection terminal 532 connected to the filter 35. In a plan view of the module substrate 90, the filter 35 may be disposed between the power amplifier 11B and the filter 31.

Accordingly, heat transfer from the power amplifier 11B to the filter 31 is also reduced by the filter 35 in addition to the filter 32. Therefore, it is possible to further suppress deterioration of characteristics of the filter 31 due to an increase in temperature of the filter 31 caused by heat generated in the power amplifier 11B.

### Modification of Embodiment 3

Next, a modification of Embodiment 3 will be described. In the present modification, the arrangement of the filters 31 to 33 and 35 and the power amplifier 12B on the principal surface 90a of the module substrate 90 is mainly different from that in Embodiment 3. Hereinafter, the present modification will be described with reference to the drawings, focusing on differences from Embodiment 3. Note that the circuit configurations of the communication device 5B and the radio-frequency module 1B according to the present modification are the same as those of the communication device 5B and the radio-frequency module 1B according to Embodiment 3, and therefore illustration and description thereof are omitted.

### 3.4 Implementation Example of Radio-frequency Module 1B

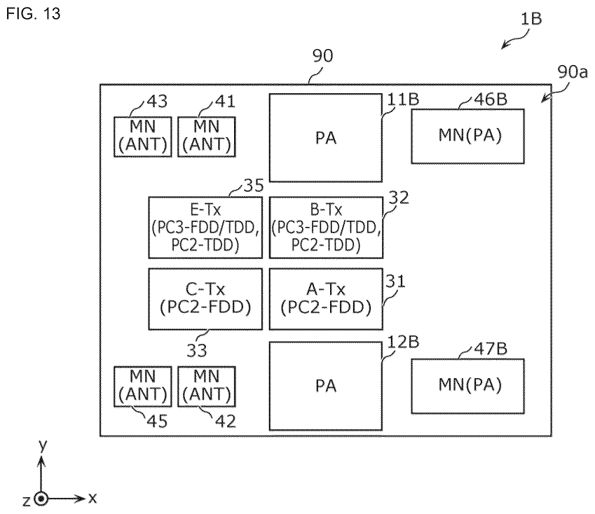

An implementation example of the radio-frequency module 1B according to the present modification will be described with reference to FIG. 13. FIG. 13 is a plan view of the radio-frequency module 1B according to the present modification. In FIG. 13, in order to facilitate understanding of arrangement relationships of respective components, some of the components are provided with labels (e.g., “PA”) representing the components; however, the labels need not necessarily be provided on actual components.

Additionally, in FIG. 13, illustration of the resin members 91 and 92 covering multiple circuit components and the metal shield 93 covering the resin members 91 and 92 is omitted. Further, in FIG. 13, illustration of the filters 34 and 36 and the matching circuit 44 is omitted as well.

Note that FIG. 13 illustrates one implementation example of the radio-frequency module 1B, and the radio-frequency module 1B may be implemented using any of various circuit implementations and circuit technologies. Accordingly, the description of the radio-frequency module 1B provided below is not to be construed as limiting.

As in Embodiment 3, in a plan view of the module substrate 90, the filter 32 is disposed between the power amplifier 11B and the filters 31 and 33. Further, in a plan view of the module substrate 90, the filter 31 is disposed between the power amplifier 12B and the filters 32 and 35.

### 3.5 Conclusion

As described above, in the radio-frequency module 1B according to the present modification, the filter 31 may be disposed between the power amplifier 12B and the filter 32 in a plan view of the module substrate 90.

Accordingly, heat transfer from the power amplifier 12B to the filter 32 is also reduced by the filter 31 disposed between the power amplifier 12B and the filter 32. Therefore, it is possible to suppress deterioration of characteristics of the filter 32 due to an increase in temperature of the filter 32 caused by heat generated in the power amplifier 12B.

### Other Embodiments

Although the radio-frequency module according to the present disclosure has been described above based on the embodiments, the radio-frequency module according to the present disclosure is not limited to the embodiments described above. Other embodiments realized by combining any components of the above-described embodiments, and modified examples obtained by applying various modifications that may be conceived by those skilled in the art without departing from the spirit of the present disclosure, as well as various devices incorporating the above-described radio-frequency module, are also included in the present disclosure.

For example, in the circuit configuration of various circuits according to the above-described embodiments, other circuit elements or wirings may be inserted in the paths connecting the circuit elements and signal paths disclosed in the drawings. For example, a matching circuit and/or a switch circuit may be provided between the low-noise amplifier 21 and the filter 36.

### INDUSTRIAL APPLICABILITY

The present disclosure can be widely used as a radio-frequency module or a communication device disposed in a front-end portion for communication equipment such as mobile phones.

### REFERENCE SIGNS LIST

1, 1A, 1B radio-frequency modules
2 antenna
3 RFIC
4 BBIC
5, 5A, 5B communication devices
11, 11B, 12B power amplifiers
20, 20B integrated circuits
21 low-noise amplifier
31, 32, 33, 34, 35, 36, 37 filters
41, 42, 43, 44, 45, 46, 46B, 47B matching circuits
50, 51, 52, 53 switch circuits
61, 62 metal members
90 module substrate
90a, 90b principal surfaces
91, 92 resin members
93 metal shield
94 external connection terminals
100 antenna connection terminal
111, 112 radio-frequency input terminals
121 radio-frequency output terminal
301 piezoelectric layer
302 low-acoustic-velocity layer
303 high-acoustic-velocity layer
304 support substrate
305 IDT electrode
312 low-acoustic-impedance layer
313 high-acoustic-impedance layer
322 intermediate layer
500, 510, 520, 530 common terminals
501, 502, 503, 504, 505, 511, 512, 513, 514, 515, 521, 522, 523, 531, 532 selection terminals
A, B, C, D, E bands

1. A radio-frequency module comprising:
a module substrate;
a first power amplifier disposed on the module substrate;
a first filter disposed on the module substrate, the first filter having a passband that includes a transmission band of a first frequency division duplex (FDD) band corresponding to a first power class, and connected to the first power amplifier; and
a second filter disposed on the module substrate, the second filter having a passband that includes a transmission band of a second FDD band corresponding to a second power class defined by a maximum output power lower than that of the first power class, a first time division duplex (TDD) band corresponding to the first power class, or a second TDD band corresponding to the second power class,
wherein, in a plan view of the module substrate, the second filter is disposed between the first power amplifier and the first filter.

2. The radio-frequency module according to claim 1, further comprising:
a first switch circuit disposed on the module substrate and including a first common terminal connected to an output end of the first power amplifier, a first selection terminal connected to the first filter, and a second selection terminal connected to the second filter.

3. The radio-frequency module according to claim 2, further comprising:
a third filter disposed on the module substrate and having a passband that includes a transmission band of a third FDD band corresponding to the first power class,
wherein the first switch circuit further includes a third selection terminal connected to the third filter, and
wherein, in a plan view of the module substrate, the second filter is disposed between the first power amplifier and the third filter.

4. The radio-frequency module according to claim 2, further comprising:
a fourth filter disposed on the module substrate and having a passband that includes a transmission band of a fourth FDD band corresponding to the first power class,
wherein the first switch circuit further includes a fourth selection terminal connected to the fourth filter, and
wherein, in a plan view of the module substrate, the second filter is disposed between the first power amplifier and the fourth filter.

5. The radio-frequency module according to claim 2, further comprising:
a fifth filter disposed on the module substrate and having a passband that includes a transmission band of a fifth FDD band corresponding to the second power class, a third TDD band corresponding to the first power class, or a fourth TDD band corresponding to the second power class,
wherein the first switch circuit further includes a fifth selection terminal connected to the fifth filter, and
wherein, in a plan view of the module substrate, the fifth filter is disposed between the first power amplifier and the first filter.

6. The radio-frequency module according to claim 1, further comprising:
a low-noise amplifier disposed on the module substrate; and
a sixth filter disposed on the module substrate, having a passband that includes a reception band of the first FDD band, and connected to the low-noise amplifier,
wherein, in a plan view of the module substrate, the second filter is disposed between the first power amplifier and the sixth filter.

7. The radio-frequency module according to claim 6, wherein:
in a plan view of the module substrate, the sixth filter is disposed between the first power amplifier and the first filter.

8. The radio-frequency module according to claim 6, wherein:
in a plan view of the module substrate, the first filter is closer to an outer edge of the module substrate than the sixth filter.

9. The radio-frequency module according to claim 6, wherein:
in a plan view of the module substrate, the first filter is disposed between the first power amplifier and the sixth filter.

10. The radio-frequency module according to claim 1, wherein:
the passband of the second filter includes the transmission band of the second FDD band; and
the radio-frequency module further comprises:
a low-noise amplifier disposed on the module substrate; and
a seventh filter disposed on the module substrate, having a passband that includes a reception band of the second FDD band, and connected to the low-noise amplifier,
wherein, in a plan view of the module substrate, the seventh filter is disposed between the first power amplifier and the first filter.

11. The radio-frequency module according to claim 1, further comprising:
a matching circuit connected between the first power amplifier and the first filter, and, in a plan view of the module substrate, disposed between the first power amplifier and the first filter.

12. The radio-frequency module according to claim 1, further comprising:
a metal partition disposed between the first power amplifier and the first filter in a plan view of the module substrate.

13. The radio-frequency module according to claim 1, further comprising:
a second power amplifier disposed on the module substrate and connected to the second filter.

14. The radio-frequency module according to claim 13, further comprising:
a third filter disposed on the module substrate and having a passband that includes a transmission band of a third FDD band corresponding to the first power class; and
a second switch circuit disposed on the module substrate and including a second common terminal connected to the output end of the first power amplifier, a sixth selection terminal connected to the first filter, and a seventh selection terminal connected to the third filter,
wherein, in a plan view of the module substrate, the second filter is disposed between the first power amplifier and the third filter.

15. The radio-frequency module according to claim 14, further comprising:
a fourth filter disposed on the module substrate and having a passband that includes a transmission band of a fourth FDD band corresponding to the first power class,
wherein the second switch circuit further includes an eighth selection terminal connected to the fourth filter, and
wherein, in a plan view of the module substrate, the second filter is disposed between the first power amplifier and the fourth filter.

16. The radio-frequency module according to claim 13, further comprising:
a fifth filter disposed on the module substrate and having a passband that includes a transmission band of a fifth FDD band corresponding to the second power class, a third TDD band corresponding to the first power class, or a fourth TDD band corresponding to the second power class; and
a third switch circuit disposed on the module substrate and including a third common terminal connected to an output end of the second power amplifier, a ninth selection terminal connected to the second filter, and a tenth selection terminal connected to the fifth filter,
wherein, in a plan view of the module substrate, the fifth filter is disposed between the first power amplifier and the first filter.

17. The radio-frequency module according to claim 13, wherein:
in a plan view of the module substrate, the first filter is disposed between the second power amplifier and the second filter.

18. The radio-frequency module according to claim 1, wherein:
the module substrate has a first principal surface and a second principal surface facing each other;
the first power amplifier, the first filter, and the second filter are disposed on the first principal surface;
the radio-frequency module further comprises:
a plurality of external connection terminals disposed on the second principal surface;
an encapsulant disposed on the first principal surface and covering at least a portion of the first power amplifier, the first filter, and the second filter; and
a metal shield covering at least a portion of a surface of the resin encapsulant; and
at least a portion of the second filter is in contact with the metal shield.

19. The radio-frequency module according to claim 1, wherein:
the first filter is a surface acoustic wave filter including a piezoelectric layer and a support substrate; and
the support substrate is formed of a semiconductor material having a bandgap larger than that of silicon or an insulating material.

20. The radio-frequency module according to claim 1, wherein:
the first filter is a surface acoustic wave filter including a piezoelectric layer and a support substrate; and
the support substrate is formed of at least one selected from silicon carbide (SiC), gallium nitride (GaN), gallium oxide (Ga₂O₃), diamond, aluminum nitride (AlN), sapphire, spinel (MgAl₂O₄), yttrium aluminum garnet (Y₃Al₅O₁₂), quartz, mullite (3Al₂O₃2SiO₂ or 2Al₂O₃SiO₂), and SiAlON.
